(19) United States
(12) Patent Application Publication
(10) Pub. No.: US 2009/0249002 A1
(43) Pub. Date: Oct. 1, 2009

(54) INFORMATION COLLECTION APPARATUS, METHOD, AND PROGRAM

(75) Inventors: Shuichiro IMAHARA, Kawasaki-shi (JP); Kazuto Kubota, Kawasaki-shi (JP); Mototaka Kanematsu, Yokohama-shi (JP); Akiko Matsukawa, Tokyo (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Kabushiki Kaisha Toshiba

(21) Appl. No.: 12/403,196

(22) Filed: Mar. 12, 2009

(30) Foreign Application Priority Data
Mar. 27, 2008 (JP) 2008-083679

(51) Int. Cl. G06F 12/02; G06F 12/00; G06F 3/00; G06F 1/28

(52) U.S. Cl. 711/161; 710/14; 710/8; 713/300; 711/E12.001

(57) ABSTRACT

An information collection apparatus which collects, from a plurality of devices each having a plurality of states including a power-supply state indicating ON or OFF of a power-supply, state information indicating a state of each device, the apparatus (a) stores, in a first memory, the power-supply state of each device, (b) receives state information transmitted from each device whose state is changed, (c) rewrites, when a power-supply state information indicating the power-supply state is received, the power-supply state stored in the first memory in accordance with the obtained power-supply state information, (d) collects periodically the state information from each device whose power-supply state stored in the first memory is ON by issuing, at regular intervals, a first request for the state information to the device, and (e) transmits the state information collected periodically to an external apparatus.

### CROSS-REFERENCE TO RELATED APPLICATIONS

This application is based upon and claims the benefit of priority from prior Japanese Patent Application No. 2008-083679, filed Mar. 27, 2008, the entire contents of which are incorporated herein by reference.

### BACKGROUND OF THE INVENTION

1. Field of the Invention

The present invention relates to an information collection apparatus which collects information from various devices installed in premises used as homes, offices, and other facilities.

2. Description of the Related Art

In order to perform device control in accordance with living conditions in a system which intensively controls home electric appliances, home equipment, and the like, inhabitants need to manually press buttons and the like in which device control contents are registered for the respective living conditions in accordance with living conditions as disclosed in JP-A 2006-350819 (Kokai) and JP-A 2004-295408 (Kokai).

To implement automatic device control in accordance with situations, it is necessary to perform device control in consideration of living conditions such as the behaviors of inhabitants. In order to calculate living conditions, it is necessary to collect many pieces of state information (the states (ON/OFF) of power supplies, operation states indicating detection/measurement results obtained by the devices, the states of manipulations and operations, and the like) from many devices.

Assume that many pieces of state information are periodically collected from many devices installed in, for example, homes by making inquiries to the respective devices. In this case, if no response is returned from one of these devices within a predetermined time because of, for example, a failure or power-off to result in a timeout, it requires much time to collect state information from all the devices. As the number of devices in which timeouts have occurred increases, such a delay time increases.

When such a delay occurs, a delay also occurs in the time from when state information is collected from each device to when the device is controlled by using the collected state information.

### BRIEF SUMMARY OF THE INVENTION

According to embodiments of the present invention, there is provided an information collection apparatus which collects, from a plurality of devices each having a plurality of states including a power-supply state indicating ON or OFF of a power-supply, state information indicating a state of each device.

The apparatus includes:

a first memory to store the power-supply state of each device;

a nonperiodic collection unit configured to receive state information transmitted from each device whose state is changed;

a first update unit configured to rewrite, when a power-supply state information indicating the power-supply state is obtained by the nonperiodic collection unit, the power-supply state stored in the first memory in accordance with the obtained power-supply state information;

a first periodic collection unit configured to collect the state information from each device whose power-supply state stored in the first memory is ON by issuing, at regular intervals, a first request for the state information to the device; and

a transmission unit configured to transmit the state information collected by the first periodic collection unit to an external apparatus.

### BRIEF DESCRIPTION OF THE SEVERAL VIEWS OF THE DRAWING

FIG. 1 is a block diagram showing an example of the overall arrangement of a device control system;

FIG. 2 is a block diagram showing an example of the arrangement of an information collection apparatus;

FIG. 3 is a view showing an example of information stored in a storage unit;

FIG. 4 is a view showing an example of storing, in a storage unit, a time Ta for the determination of a timeout-a in the first periodic collection process and a time Tb for the determination of a timeout-b in the second periodic collection process;

FIG. 5 is a view showing an example of storing, in the storage unit, two thresholds, Tha and Thb, for the occurrence ratio of the timeout-a;

FIG. 6 is a flowchart for explaining nonperiodic processing operation by a nonperiodic processing unit;

FIG. 7 is a flowchart for explaining periodic processing operation by a periodic processing unit;

FIG. 8 is a flowchart for explaining another periodic processing operation in a periodic process;

FIG. 9 is a flowchart for explaining abnormality processing operation by an abnormality processing unit; and

FIG. 10 is a block diagram showing another example of the arrangement of the information processing apparatus.

### DETAILED DESCRIPTION OF THE INVENTION

An embodiment of the present invention will be described below with reference to the views of the accompanying drawing.

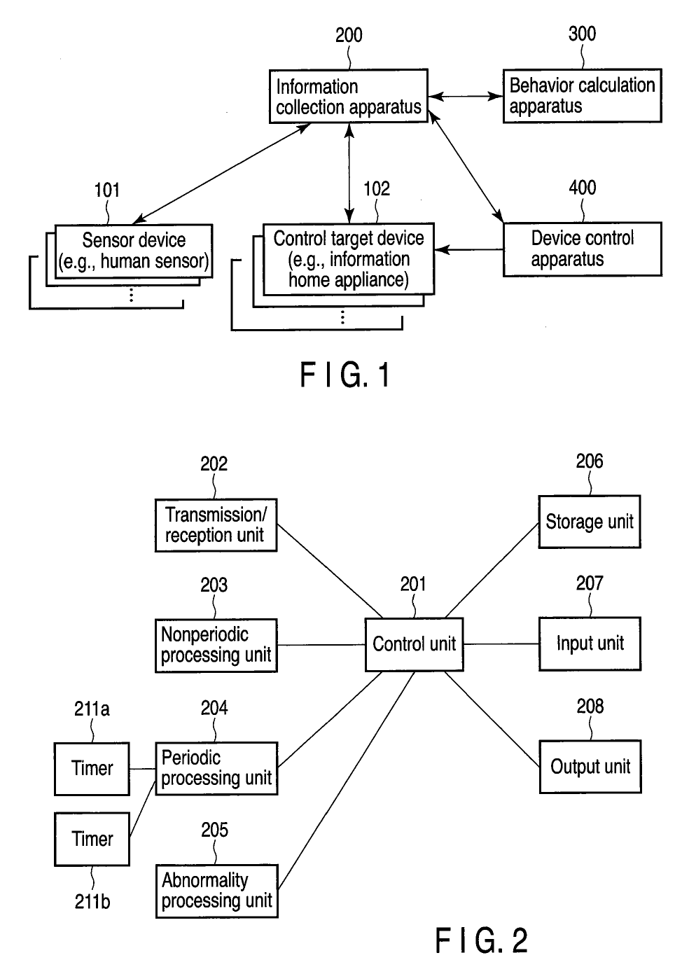

FIG. 1 shows an example of a device control system according to this embodiment. This system includes a plurality of sensor devices 101, a plurality of control target devices 102, an information collection apparatus 200, a behavior calculation apparatus 300, and a device control apparatus 400.

The sensor device 101 is a device which detects/measures a person or an environment, e.g., a human sensor, illuminance sensor, temperature sensor, or humidity sensor. This device transmits, to the information collection apparatus 200, state information such as the state (ON/OFF) of the power-supply of the device and an operation state indicating the detection/measurement result obtained by the device.

The control target device 102 is a home electric appliance, home equipment, or information device. This device transmits state information indicating the state of the device (e.g., the operation state of the power-supply of the device or operation/manipulation) to the information collection apparatus 200 by the same method as that for the sensor device 101. The device also receives a device control signal from the device control apparatus 400 and operates as instructed.

The detection/measurement results obtained by devices such as the sensor devices 101 and control target devices 102, the state of the devices, and the like will be collectively referred to as the “states” of the devices. Information representing such a state notified to the information collection apparatus 200 will be referred to as “state information”.

The sensor devices 101 and the control target devices 102 transmit state information by two types of methods: a nonperiodic state notification method of making each device transmit state information to the information collection apparatus 200 when the state of the device has changed; and a periodic state notification method of making the information collection apparatus 200 periodically request the devices 101 and 102 to transmit state information and making each device transmit state information in response to the request.

The information collection apparatus 200 collects the state information transmitted from the sensor device 101 or the control target device 102, and transmits the state information to the behavior calculation apparatus 300.

The behavior calculation apparatus 300 calculates the feature amount of each device, the feature amount of the behavior of a person, the feature amount of the state of a room, or the like on the basis of the state information of each device in accordance with programs held in the apparatus, and transmits the feature amounts of calculation results to the information collection apparatus 200.

Upon receiving the feature amounts, the information collection apparatus 200 transmits the feature amounts to the device control apparatus 400 together with the state information received from the sensor device 101 or the control target device 102.

The device control apparatus 400 receives the state information of each device and each type of feature amount transmitted from the information collection apparatus 200, and determines on the basis of these pieces of current information whether it is necessary to change control on the device. Upon determining that the control needs to be changed, the device control apparatus 400 transmits a device control signal to the control target device 102 to control the device. Typical services using such device control include an energy-saving automatic control service such as an automatic device turn-off service, an intruder detection service, an elder/child watching service, and the like.

FIG. 2 shows an example of the arrangement of the information collection apparatus 200. This apparatus includes a control unit 201, a transmission/reception unit 202, a nonperiodic processing unit 203, a periodic processing unit 204, an abnormality processing unit 205, a storage unit 206, an input unit 207, an output unit 208, a timer 211a, and a timer 211b.

A control unit 210 is in charge of overall control of the information collection apparatus 200.

The transmission/reception unit 202 performs communication between the sensor devices 101, the control target devices 102, the behavior calculation apparatus 300, and the device control apparatus 400.

Assume that the state of the sensor device 101 or 102 has changed. In this case, when the transmission/reception unit 202 receives a nonperiodic state notification which transmits state information indicating a new state after the change from the device to the information collection apparatus 200, the control unit 201 activates the nonperiodic processing unit 203 to start processing corresponding to the nonperiodic state notification.

The control unit 201 periodically activates the periodic processing unit 204. The periodic processing unit 204 starts a periodic process, to be described later.

After the periodic process performed by the periodic processing unit 204, the control unit 201 activates the abnormality processing unit 205 to make it execute an abnormality process.

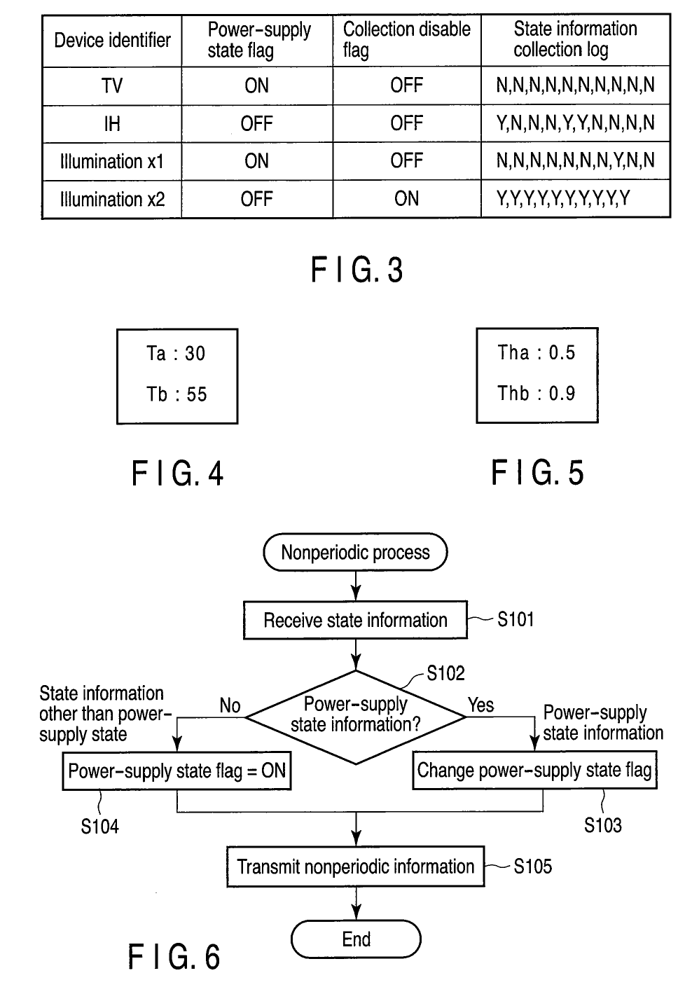

The storage unit 206 stores a list of devices (connected to the information collection apparatus 200) from which the information collection apparatus 200 should collect state information. This list contains the identifiers of the respective devices and address information such as ECHONET (Energy Conservation and Homecare Network) addresses necessary for the exchange of messages between the respective devices, MAC (Media Access Control) addresses, IP (Internet Protocol) addresses, and URLs (Uniform Resource Locators). The storage unit 206 also stores power-supply state flags, collection disable flags, state information collection logs, and the like in correspondence with the respective devices 101 and 102 (their identifiers). FIG. 3 shows an example of information stored in the storage unit 206.

The power-supply state flag of each device indicates the power-supply state of the device. When the power-supply state flag is ON, it indicates that the power-supply of the device is ON. When the power-supply state flag is OFF, it indicates that the power-supply of the device is OFF.

For a device whose power-supply state flag is ON, the periodic processing unit 204 performs the first periodic collection process in a periodic process to collect various types of state information of the device which include the power-supply state (ON/OFF) of the device and the operation or manipulation state of the device.

For a device whose power-supply state flag is OFF, the periodic processing unit 204 performs the second periodic collection process in a periodic process to check only the power-supply state of the device.

When the collection disable flag is ON, it indicates that the power-supply of the corresponding device is OFF or the operation result of a periodic state notification from the device is unstable (to such an extent that an abnormality or failure is suspected in the device or the communication channel (network) between the device and the information collection apparatus 200) even though the power-supply of the corresponding device is ON.

For a device whose collection disable flag is OFF, the periodic processing unit 204 performs a periodic process. For a device whose collection disable flag is ON, the periodic processing unit 204 does not perform a periodic process.

In the first periodic collection process in a periodic process performed by the periodic processing unit 204, the periodic processing unit 204 measures, by using a timer 211a, the time elapsed since a request for state information was issued to the device. If a response (periodic state notification message) of notifying state information is not received from the device via the transmission/reception unit 202 within a predetermined time Ta, the periodic processing unit 204 determines a timeout (timeout-a) (the occurrence of the timeout-a). Upon determining the timeout-a, the periodic processing unit 204 rewrites the power-supply state flag for the device from ON to OFF, and records, as a state information collection log, information indicating that the state information collection result is a failure. If state information is received within the time Ta, the periodic processing unit 204 records, as a state information collection log, information indicating that the state information collection result is a success, without changing the power-supply state flag (power-supply state flag=ON).

According to the state information collection log shown in FIG. 3, “N” represents that the timeout-a has not occurred when the state information collection result in the first periodic collection process was a success, and “Y” represents that the timeout-a has occurred when the state information collection result was a failure.

In the second periodic collection process in a periodic process, the periodic processing unit 204 measures, by using a timer 211b, the time elapsed since a request for power-supply state information was issued to a device whose power-supply state flag is OFF. If a response (power-supply state notification message) of notifying power-supply state information is not received from the device via the transmission/reception unit 202 within a predetermined time Tb, the periodic processing unit 204 determines a timeout (timeout-b). Upon determining the timeout-b, the periodic processing unit 204 keeps the power-supply state flag for the device OFF. If power-supply state information is received within the time Tb, the periodic processing unit 204 changes the power-supply state flag from OFF to ON.

The time Ta for the determination of the timeout-a in the first periodic collection process and the time Tb for the determination of the timeout-b in the second periodic collection process are stored in the storage unit 206 in advance, as shown in, for example, FIG. 4.

According to the example shown in FIG. 4, the time Ta for the determination of the timeout-a in the first periodic collection process is 30 sec. If a response (periodic state notification message) of notifying state information is not received from a device via the transmission/reception unit 202 within time Ta=30 sec after a request for state information is issued to the device, the timeout-a is determined. The time Tb for the determination of the timeout-b in the second periodic collection process is 55 sec. If, therefore, a response (power-supply state notification message) of notifying power-supply state information is not received from a device via the transmission/reception unit 202 within time Tb=55 sec after a request for power-supply state information is issued to the device, the timeout-b is determined.

If the power-supply state flag is rewritten from ON to OFF in the first periodic collection process as described above (i.e., the timeout-a is determined), the control unit 201 activates the abnormality processing unit 205. The abnormality processing unit 205 performs an abnormality process (to be described later) for the device whose power-supply state flag is OFF.

In the abnormality process, if a state information collection log corresponding to a device reveals, on the basis of the number of times of occurrence of the timeout-a in the past first periodic collection processes, that the timeout-a has frequently occurred, the abnormality processing unit 205 performs processing for changing the collection disable flag from OFF to ON. For example, the abnormality processing unit 205 calculates the ratio of the number of times of occurrence of the timeout-a to the number of times of the first periodic collection process performed for the device in the past, i.e., the occurrence ratio of the timeout-a. If the calculated value is equal to or more than a predetermined threshold, the abnormality processing unit 205 sets the collection disable flag ON.

Assume that a state information log concerning the first periodic collection process performed 10 times in the past with respect to the device “IH” is “Y, N, N, N, Y, Y, N, N, N, N”, as shown in FIG. 3. In this case, three “Y”s in the 10 first periodic collection processes indicate that the timeout-a has occurred three times. Therefore, the occurrence ratio of the timeout-a is “0.3”. Referring to FIG. 3, the log of the past 10 processes is stored. However, it suffices to change this operation in accordance with the characteristics of the system.

Two thresholds for the occurrence ratio of the timeout-a are set, including a threshold Tha having a smaller value and a threshold Thb having a larger value. If the occurrence ratio of the timeout-a is equal to or more than the threshold Tha, the abnormality processing unit 205 performs only abnormality notification to the user (notifies that a device with the timeout-a occurrence ratio equal to or more the threshold Tha is detected). If the timeout-a occurrence ratio is equal to or more than the threshold Thb, it suffices to set the collection disable flag ON.

The thresholds Tha and Thb are stored in the storage unit 206, as shown in, for example, FIG. 5.

Referring to FIG. 5, the threshold Tha is 0.5, and the threshold Thb is 0.9. In this case, if information indicating that the timeout-a has occurred five times in the 10 first periodic collection processes performed in the past is recorded in the state information collection log in FIG. 3, the abnormality processing unit 205 performs only abnormality notification to the user. In contrast, if information indicating that the timeout-a has occurred nine or more times in the 10 first periodic collection processes is recorded in the log, the abnormality processing unit 205 sets the collection disable flag ON while performing abnormality notification to the user.

If the collection disable flag is set ON once, no periodic process is performed for the corresponding device. That is, this system performs neither the first periodic collection process for the collection of various types of state information of the device nor the second periodic collection process of checking only the power-supply state of the device. That the collection disable flag is ON is based on the assumption of a defect in the device. Therefore, in order to restore this state, the collection disable flag is set OFF by another means after the cause of the defect is removed. For example, the collection disable flag of a device which is stored in the storage unit 206 can be rewritten to OFF by using the input unit 207 via the control unit 201. Alternatively, the collection disable flag of a device which is stored in the storage unit 206 (from, for example, the device) can be rewritten to OFF via the transmission/reception unit 202 and the control unit 201.

The input unit 207 is used to input, to the information collection apparatus 200, the operation signal or data input from an input device such as a keyboard or mouse.

The output unit 208 performs display processing for displaying the processing results obtained by the nonperiodic processing unit 203, the periodic processing unit 204, and the abnormality processing unit 205 and the like on a display such as an LCD (Liquid Crystal Display) or CRT (Cathode Ray Tube) under the control of the control unit 201.

The processing operation (i.e., the nonperiodic process) of the nonperiodic processing unit 203 will be described next with reference to the flowchart shown in FIG. 6.

When the state of the sensor device 101 or control target device 102 has changed (for example, when the sensor device 101 has detected a detection target or has changed in measured value upon turn-on of the power-supply or operation by the user), the device transmits a nonperiodic state notification (including new state information after the change) to the information collection apparatus 200 to notify it of the new state information. When the transmission/reception unit 202 receives this nonperiodic state notification, the control unit 201 activates the nonperiodic processing unit 203. The nonperiodic state notification is transferred to the nonperiodic processing unit 203 to start processing corresponding to the nonperiodic state notification (step S101).

If the nonperiodic processing unit 203 determines in step S102 that the received nonperiodic state notification contains power-supply state information representing the power-supply state of the device, the process advances to step S103. The nonperiodic processing unit 203 then changes the power-supply state flag stored in the storage unit 206 in correspondence with the device on the basis of the power-supply state information. If the nonperiodic processing unit 203 determines in step S102 that the received nonperiodic state notification contains no power-supply state information of the device but contains state information other than power-supply state information, it can be regarded that the device is operating, i.e., the power-supply is ON (various types of state information can be transmitted because the power-supply is ON). In this case, the process advances from step S102 to step S104 to rewrite the power-supply state flag corresponding to the device to ON. Note that step S104 can be omitted.

The process then advances to step S105 to transmit the state information notified from the device to the behavior calculation apparatus 300 (nonperiodic information transmission).

The power-supply state flag updated by the above nonperiodic process can be used in a periodic state information collection process (periodic process) performed by the periodic processing unit 204.

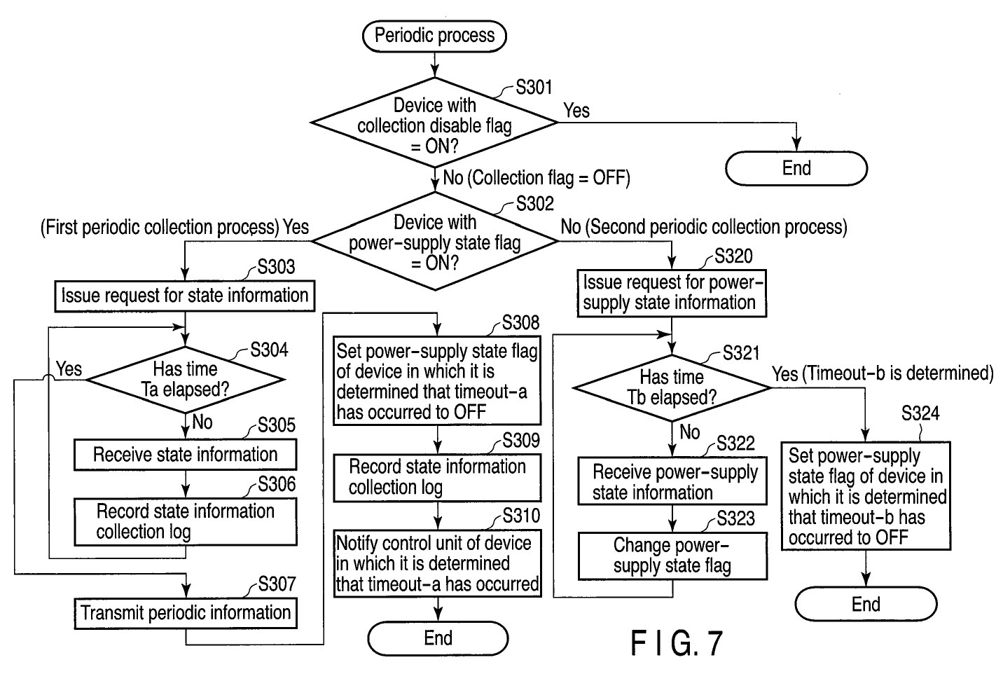

The processing operation (i.e., the periodic process) of the periodic processing unit 204 will be described next with reference to FIG. 7.

The control unit 201 activates the periodic processing unit 204 at predetermined time intervals (at regular intervals). The control unit 210 includes a timer (not shown) to measure this time. Upon detecting from the timer value that the predetermined time has elapsed from the time when the previous periodic process was performed, the control unit 201 activates the periodic processing unit 204.

First of all, the activated periodic processing unit 204 selects a device group whose collection disable flags are OFF from the device list stored in the storage unit 206 (step S301). The periodic processing unit 204 does not perform the following periodic process for devices whose collection disable flags are ON. The process further advances to step S302 to divide the selected device group into a group of devices whose power-supply state flags are ON and a group of devices whose power-supply state flags are OFF by referring to the device list stored in the storage unit 206.

For the group of devices whose power-supply state flags are ON, the process advances to step S303 to start the first periodic collection process which is a normal periodic process for collecting various types of state information of the device, including the operation or manipulation state of the device. In contrast, for the group of devices whose power-supply state flags are OFF, the process advances to step S310 to start the second periodic collection process for checking only the power-supply state of each device.

In the first periodic collection process, in the case of, for example, an air conditioner device, the periodic processing unit 204 collects pieces of state information concerning a plurality of states of the device, e.g., the power-supply state, room temperature, set temperature, and operation mode.

First of all, in step S303, the periodic processing unit 204 simultaneously transmits a request message for requesting state information to the group of devices whose power-supply state flags are ON. This request message is addressed to each device whose power-supply state flag is ON. For example, the message can be multicast to the group of devices. At the same time, the periodic processing unit 204 starts measuring, by using the timer 211a, the time from when a request for state information is issued to the device.

If a response (periodic state notification message) notifying state information from a device whose power-supply state flag is ON is received via the transmission/reception unit 202 within the predetermined time Ta (steps S304 and S305), the process advances to step S306, in which the periodic processing unit 204 records, as a state information collection log, information (“N” in FIG. 3) indicating that the state information collection result is a success in the storage unit 206 in correspondence with the identifier of the device. The execution of processing for the device from which a periodic state notification message has been received within the time Ta is paused until periodic state notification messages are received from all the remaining devices. After the messages are received from all the devices, the process advances to step S307.

Note that the time (e.g., “30 sec” in FIG. 4) stored in the storage unit 206 is set as the time Ta.

When the time Ta has elapsed, the process advances to step S307 to transmit the state information in the periodic state notification message from each device, which has been obtained within the time Ta, to the behavior calculation apparatus 300 (periodic information transmission).

Thereafter, the information collection apparatus 200 calculates the feature amount of each device, the feature amount of the behavior of each person, the feature amount of the state of each room, and the like on the basis of the state information of each device in accordance with a program held in the apparatus, and transmits the feature amounts as calculation results to the information collection apparatus 200.

Upon receiving the feature amounts, the information collection apparatus 200 transmits the feature amounts to the device control apparatus 400, together with the state information received from the respective devices 101 and 102.

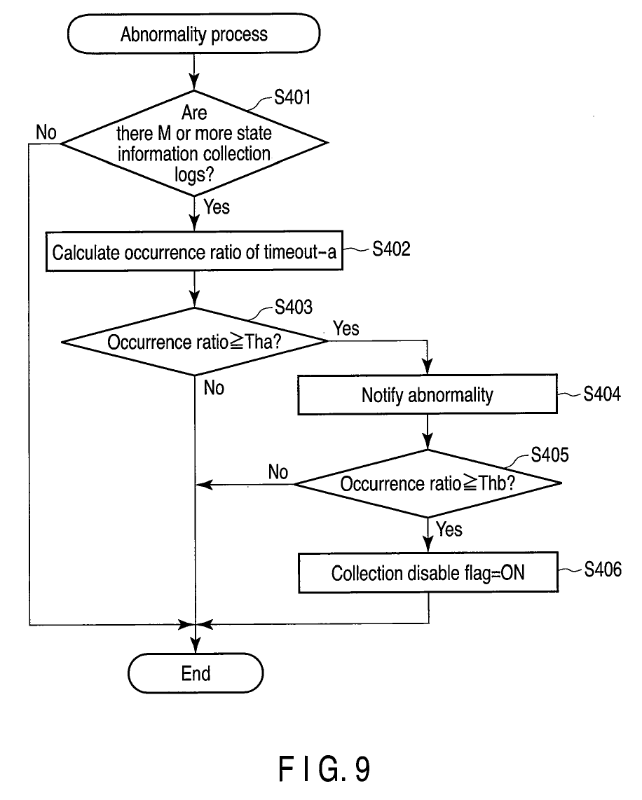

For a device from which no periodic state notification message is received via the transmission/reception unit 202 within the time Ta, the periodic processing unit 204 determines a timeout (timeout-a). For the device in which it is determined that the timeout-a has occurred, the process advances to step S308 to rewrite the power-supply state flag stored in the storage unit 206 in correspondence with the identifier of the device from ON to OFF. The periodic processing unit 204 records, as a state information collection log, information (“Y” in FIG. 3) indicating that the state information collection result is a failure in the storage unit 206 in correspondence with the identifier of the device (step S309). The periodic processing unit 204 also notifies the control unit 201 of the device (e.g., its identifier) in which it is determined that the timeout-a has occurred (step S310). Upon receiving this information, the control unit 201 activates the abnormality processing unit 205. The abnormality processing unit 205 performs the abnormality process (to be described later) shown in FIG. 9 for each device corresponding to the identifier.

For the group of devices whose power-supply state flags are OFF, the process advances to step S320 to start the second periodic collection process for checking only the power-supply state of the many states which each device has.

In the second periodic collection process, the periodic processing unit 204 simultaneously or sequentially transmits a request message for requesting power-supply state information to the devices whose power-supply state flags are OFF (step S320). This request message is addressed to each device whose power-supply state flag is OFF. For example, the message can be multicast to the group of devices. At the same time, the periodic processing unit 204 starts measuring, by using the timer 211b, the time from when a request for power-supply state information is issued to the device.

If a response (power-supply state notification message) notifying power-supply state information from a device whose power-supply state flag is OFF is received via the transmission/reception unit 202 within the predetermined time Tb (steps S321 and S322), the process advances to step S323, in which the periodic processing unit 204 changes the power-supply state flag stored in the storage unit 206 in correspondence with the identifier of the device in accordance with the received power-supply state information. If the power-supply state information represents ON, the periodic processing unit 204 rewrites the power-supply state flag to ON. If the power-supply state information represents OFF, the periodic processing unit 204 rewrites the power-supply state flag to OFF. For a device from which a power-supply state notification message is received within the time Tb, the periodic processing unit 204 repeats steps S322 and S323.

Note that the time (e.g., “55 sec” in FIG. 4) stored in the storage unit 206 is set as the time Tb.

When the time Tb has elapsed, the process advances to step S324. For a device from which a power-supply state notification message has not been received via the transmission/reception unit 202 within the time Tb, the periodic processing unit 204 determines a timeout (timeout-b). In step S324, the periodic processing unit 204 rewrites the power-supply state flag stored in the storage unit 206 in correspondence with the identifier of the device to OFF for the device in which it is determined that the timeout-b has occurred.

Note that it suffices to perform steps S320 to S324 for each device in the second periodic collection process.

In the periodic process shown in FIG. 7, the periodic processing unit 204 performs the process of collecting normal state information, i.e., the first periodic collection process, for a device whose power-supply state flag is ON and from which it is likely to collect state information. For a device whose power-supply state flag is OFF and from which it is unlikely to collect state information, the periodic processing unit 204 performs the second periodic collection process of checking only power-supply state information independently of the first periodic process. In the first periodic process, since the periodic processing unit 204 collects state information from only a device from which it is likely to collect state information, the time (Ta in this case) for the determination of a timeout can be shorter than that in the prior art. In addition, in the first periodic collection process, the periodic processing unit 204 collects state information from only a device from which it is likely to collect state information. In the first periodic collection process, therefore, the probability of occurrence of the timeout-a is low. Therefore, even in a device from which a response (state information notification message) cannot be received within the time Ta, the delay time falls within the time Ta at most. Shortening the delay in the periodic information collection process by the information collection apparatus 200 can shorten the delay time between the instant the behavior calculation apparatus 300 performs calculation processing after the information collection apparatus 200 collects state information from each device whose power-supply is ON and the instant the device control apparatus 400 controls each of the devices 101 and 102 on the basis of the calculation result.

In addition, even if a change in the state of the device due to nonperiodic state notification shown in FIG. 6 cannot be received due to a defect in a network or the device, the second periodic collection process is performed to inquire about only the state information of the power-supply state. For a device in which it is determined in the second periodic collection process that the power-supply state is ON or a device in which it is determined in a nonperiodic process that the power-supply state is ON, the first periodic collection process described above is performed in the next periodic process cycle.

The above description has exemplified the case in which a request message is simultaneously transmitted to corresponding devices in the first periodic collection process and the second periodic collection process. However, the present invention is not limited to this.

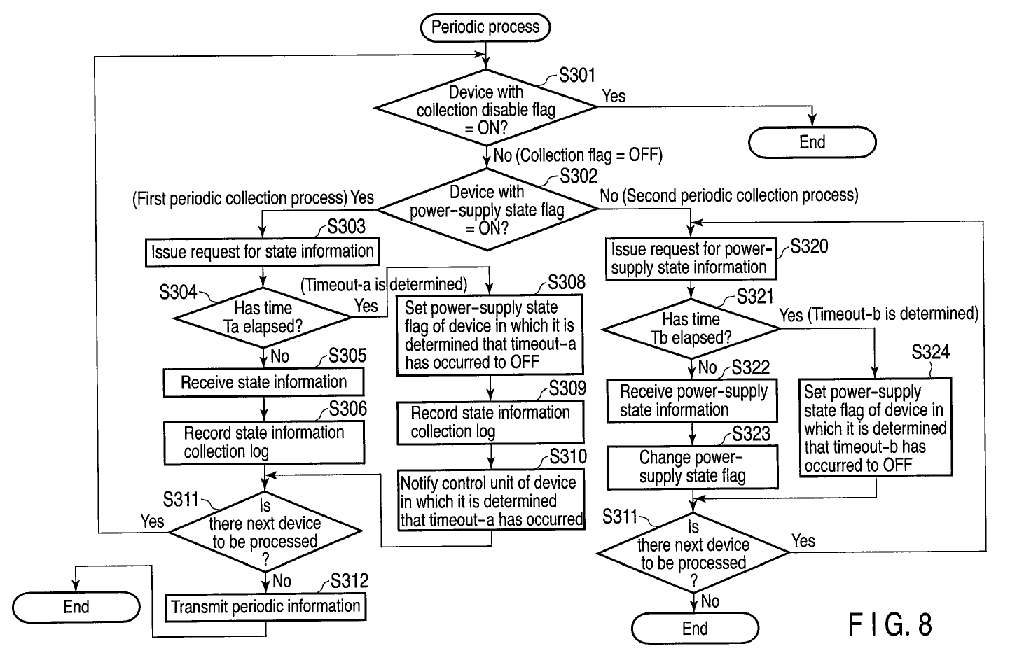

For example, as shown in FIG. 8, state information may be sequentially collected from the respective devices (one by one) belonging to the group of devices whose power-supply state flags are on. That is, after a request message is sent to one device and a response is obtained from the device (after the time Ta), a request message is transmitted to the next device. In this case, first of all, after the first periodic process for all the devices whose power-supply state flags are ON is complete (after the periodic information transmission in step S312 in FIG. 8 is performed), the second periodic process is performed for each device whose power-supply state is OFF.

Referring to FIG. 8, after steps S303 to S311 are sequentially performed for each device whose power-supply state flag is ON and the processing in steps S303 to S311 is complete for all the devices whose power-supply state flags are ON, the process advances from step S311 to step S312 to perform periodic information transmission as in step S307 in FIG. 7.

After the periodic information transmission in step S312 is performed, the process advances to step S320 to perform the second periodic collection process for each device whose power-supply state flag is OFF.

Referring to FIG. 8, steps S320 to S324 are sequentially performed for each device whose power-supply state flag is OFF. Note that in the case shown in FIG. 8, steps S320 to S324 are independently performed for each device. However, the present invention is not limited to this. As in the case shown in FIG. 7, it suffices to simultaneously transmit a power-supply state request message to all the devices whose power-supply state flags are OFF. In addition, the processing in steps S320 to S324 can be omitted.

Furthermore, the time intervals at which the first periodic collection process is performed for devices whose power-supply state flags are ON can differ from the time intervals at which the second periodic collection process is performed for devices whose power-supply state flags are OFF. That is, the first and second periodic collection processes can be performed in different time periods.

Referring to FIG. 8, in the first periodic collection process, state information is collected from only devices from which it is likely to collect state information. In the first periodic collection process, therefore, even the longest time required to collect state information falls within Ta per device, and the probability of occurrence of the timeout-a is low. As in the case shown in FIG. 7, a delay in a periodic information collection process by the information collection apparatus 200 can be reduced as compared with the prior art. This can therefore shorten the time delay from the time the information collection apparatus 200 collects state information from each device whose power-supply is ON to the time the behavior calculation apparatus 300 performs calculation processing and the device control apparatus 400 controls each of the devices 101 and 102 on the basis of the calculation processing result.

FIG. 9 is a flowchart for explaining the processing operation of the abnormality processing unit 205 which is activated when the detection of the timeout-a in step S310 in FIGS. 7 and 8 is notified to the control unit 201.

In step S308 in FIGS. 7 and 8, the abnormality processing unit 205 performs an abnormality process like that shown in FIG. 9 for a device whose power-supply state flag is OFF.

In the abnormality process, first of all, in step S401, the abnormality processing unit 205 checks whether M (M is a predetermined number, e.g., “10” in the above case) or more state information collection logs of the device are stored in the storage unit 206. If the first periodic collection process has been executed for the device M or more times in the past, M or more state information collection logs of the device are stored in the storage unit 206. If the number of state information collection logs of the device stored in the storage unit 206 is less than M, the abnormality process for the device is terminated.

If M or more state information collection logs of the device are stored in the storage unit 206, the process advances to step S402.

In step S402, the abnormality processing unit 205 calculates the ratio of the number of times of occurrence of the timeout-a to the number of times (M) of the first periodic collection process performed for the device in the past, i.e., the occurrence ratio of the timeout-a (step S402). The process advances to step S403 to compare this occurrence ratio with the predetermined threshold Tha. If the occurrence ratio is equal to or more than the threshold Tha, the process advances to step S404 to generate an abnormality notification message so as to notify the user (and/or the center) of the detection of a device having a defect in the network or itself (a device in which the occurrence ratio is equal to or more than the threshold Tha) and to make the control unit 201 and the transmission/reception unit 202 notify the user (and/or the center) of the message. Alternatively, the abnormality notification message is output from the output unit 208 and displayed on a display or the like via the control unit 201. It also suffices to output a warning for the notification of a device having a defect from the output unit 208 via the control unit 201.

The process further advances from step S404 to step S405 to compare the occurrence ratio obtained in step S402 with the threshold Thb larger than the threshold Tha. If the occurrence ratio is equal to or more than the threshold Thb, the process advances to step S406 to rewrite the collection disable flag stored in the storage unit 206 in correspondence with the identifier of the device to ON.

Note that the value (e.g., “0.5” in FIG. 5) stored in the storage unit 206 is set as the threshold Tha, and the value (e.g., “0.9” in FIG. 5) stored in the storage unit 206 is set as the threshold Thb.

When the abnormality process is complete, the abnormality processing unit 205 notifies the control unit 201 of the corresponding information.

The control unit 201 may control the periodic processing unit 204 and the abnormality processing unit 205 so as to concurrently perform the abnormality process in FIG. 9 by the abnormality processing unit 205 and the periodic process by the control unit 201. In addition, after the periodic processing unit 204 finishes the periodic process in FIGS. 7 and 8 for all the devices 101 and 102, the abnormality processing unit 205 may be controlled to perform the abnormality process in FIG. 9 for each device from which the timeout-a has been detected (notified in step S310 in FIGS. 7 and 8).

Note that if M state information collection logs have already been stored in the storage unit 206 when a state information collection log is to be recorded in the storage unit 206 in steps S306 and S309 in FIG. 8, it suffices to record the latest state information collection log upon deleting the oldest log. As a consequence, the largest number of state information collection logs stored in the storage unit 206 for each device falls within M.

The above abnormality process makes it possible to notify the user or the center of the occurrence of a defect in a device in which the timeout-a has frequently occurred due to the defect in the network or itself. In addition, in the worst case, stopping the process of periodically collecting state information from the device, i.e., the device periodic process in FIG. 8, can keep a periodic cycle of state information collection normal.

Note that instead of performing abnormality notification to the user or the center in step S404 in FIG. 9, this system may omit the processing in step S104 of rewriting the power-supply state flag to ON upon receiving state information other than power-supply state information as a nonperiodic state notification from a device in the subsequent nonperiodic process in FIG. 6.

Alternatively, it suffices to perform the processing in steps S102 to S105 for the first time when receiving nonperiodic state notifications equal to or more in number than a predetermined number of times (N). The number N of times may be gradually increased every time the abnormality process in FIG. 9 is performed for the device. Performing the processing in this manner may eliminate the necessity of performing the processing of setting the collection disable flag ON in steps S405 and S406.

As described above, according to the above embodiment, this system can prevent collection of unnecessary state information by storing the notification of the power-supply state of each of the devices 101 and 102 by using a power-supply state flag and inquiring a device whose power-supply state is OFF about only the power-supply state instead of collecting many pieces of state information which the device has. This can shorten the delay time in a periodic process by the wait time required for the collection of necessary state information.

If there is a defect such as a failure in each of the devices 101 and 102 itself or there is a defect in the network between the device and the information collection apparatus 200, the system repeatedly receives or does not receive the power state information and other types of state information from the device in the nonperiodic process in FIG. 6 or the periodic process in FIG. 8. In general, if many pieces of state information are to be periodically collected from such a device with unstable operation, a timeout occurs, resulting in frequent occurrence of delay times. The above embodiment detects such an unstable state of a device by monitoring the frequency of occurrence of the timeout-a at the time of periodic collection of state information (at the time of a periodic process). When this frequency becomes more than a given threshold, this system stops periodic collection (periodic process) of state information from the device. That is, in the abnormality process in FIG. 9, an unstable state is detected by comparing the occurrence ratio of the timeout-a with the predetermined threshold Tha or Thb.

In the above embodiment, therefore, minimizing the collection of state information (periodic state information) from a device whose power-supply is OFF or a device with very unstable operation can minimize the delay of a collection cycle (periodic process cycle) for state information.

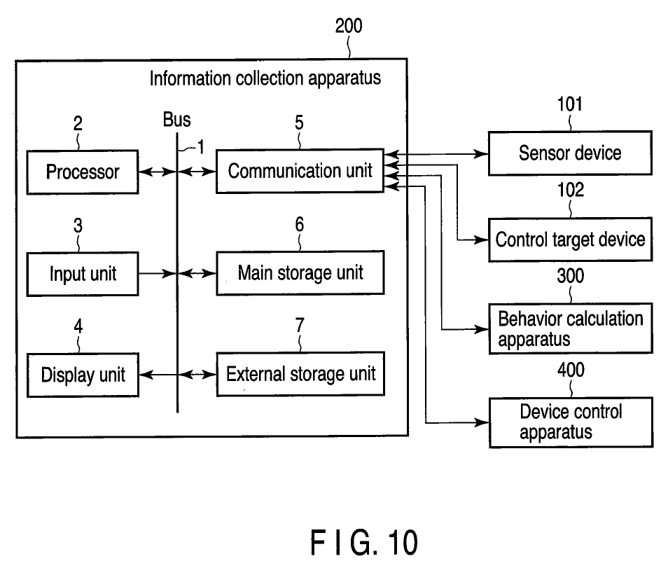

Note that the arrangement of the information collection apparatus shown in FIG. 2 can be implemented by using a general-purpose computer apparatus as basic hardware as shown in, for example, FIG. 10.

The general-purpose computer apparatus includes a processor 2, an input unit 3, a display unit 4, a communication unit 5, a main storage unit 6, and an external storage unit 7. The respective units are connected to each other via a bus 1.

The input unit 3 includes input devices such as a keyboard and mouse, and outputs an operation signal based on the operation of the input device to the processor 2.

The display unit 4 includes a display such as an LCD (Liquid Crystal Display) or CRT (Cathode Ray Tube).

The communication unit 5 includes communication means such as Ethernet (registered trademark), wireless LAN (Local Area Network), or Bluetooth (registered trademark) and communicates with the sensor devices 101, control target devices 102, behavior calculation apparatus 300, and device control apparatus 400 as external devices.

The external storage unit 7 includes a storage medium such as a hard disk, CD-R, CD-RW, DVD-RAM, or DVD-R, and stores information collection programs which cause the processor 2 to execute the processes shown in FIGS. 6 to 9.

The main storage unit 6 includes a memory and the like, in which an information collection program stored in the external storage unit 7 is expanded, and data required for the execution of the programs, data generated upon execution of the programs, and the like are stored.

The transmission/reception unit 202, nonperiodic processing unit 203, periodic processing unit 204, timers 211a and 211b, abnormality processing unit 205, input unit 207, and output unit 208 can be implemented by causing the processor 2 mounted in the above computer apparatus to execute programs. In this case, the information collection apparatus 200 may be implemented by installing the above programs in the computer apparatus in advance or by storing the programs in a storage medium such as a CD-ROM or distributing the programs via a network and installing the programs in the computer apparatus as needed. In addition, the storage unit 206 in FIG. 2 can be implemented by using a memory and a hard disk such as the main storage unit 6 and external storage unit 7 built in or externally mounted in or on the above computer apparatus or storage media such as a CD-R, DC-RW, DVD-RAM, and DVD-R, as needed.

Note that this apparatus may include a printer for printing the information shown in FIG. 3 stored in the storage unit 206, an abnormality notification, and the like, in addition to the above constituent elements. In addition, the arrangement of the information collection apparatus 200 shown in FIG. 2 may be changed in accordance with a device from which information is to be collected. For example, in the case of the device control apparatus 400 which controls an in-vehicle device, the information collection apparatus 200 is configured to control the devices 102 such as windows and an air conditioner by collecting detection results on environmental elements without using the transmission/reception unit 202.

According to the embodiment described above, there is provided an information collection apparatus and method which can minimize a delay time in the collection of state information from each device.

What is claimed is:

1. An information collection apparatus which collects, from a plurality of devices each having a plurality of states including a power-supply state indicating ON or OFF of a power-supply, state information indicating a state of each device, the apparatus comprising:
a first memory to store the power-supply state of each device;
a nonperiodic collection unit configured to receive state information transmitted from each device whose state is changed;
a first update unit configured to rewrite, when a power-supply state information indicating the power-supply state is obtained by the nonperiodic collection unit, the power-supply state stored in the first memory in accordance with the obtained power-supply state information;
a first periodic collection unit configured to collect the state information from each device whose power-supply state stored in the first memory is ON by issuing, at regular intervals, a first request for the state information to the device; and
a transmission unit configured to transmit the state information collected by the first periodic collection unit to an external apparatus.

2. The apparatus according to claim 1, wherein the first periodic collection unit includes a second update unit configured to rewrite, when not receiving the state information from the device whose power-supply state is ON within a predetermined first time after the first request is issued, the power-supply state of the device stored in the first memory to OFF.

3. The apparatus according to claim 2, further comprising a second periodic collection unit configured to collect the power-supply state information from each device whose power-supply state stored in the first memory is OFF by issuing, at regular intervals, a second request for the power-supply state information to the device.

4. The apparatus according to claim 3, wherein the second periodic collection unit includes a third update unit configured to rewrite, when receiving the power-supply state information from the device whose power-supply state is OFF within a predetermined second time after the second request is issued, the power-supply state of the device stored in the first memory in accordance with the received power-supply state information.

5. The apparatus according to claim 1, wherein the first update unit rewrites the power-supply state stored in the first memory to ON when the state information indicating a state other than the power-supply state is obtained by the nonperiodic collection unit.

6. The apparatus according to claim 2, further comprising:
a second memory to store, every time the first request is issued to the device whose power state is ON, log information indicating whether the state information from the device is received within the first time; and
a calculation unit configured to calculate an occurrence ratio of a timeout for the device based on the log information of the device, the timeout being determined to occur when not receiving the state information from the device within the first time after the first request is issued; and wherein
the first periodic collection unit does not issue the first request to the device whose occurrence ratio equal or exceed a predetermined first threshold.

7. The apparatus according to claim 3, further comprising:
a second memory to store, every time the first periodic collection unit issues the first request to the device whose power state is ON, log information indicating whether the state information is received from the device within the first time; and
a calculation unit configured to calculate an occurrence ratio of a timeout for the device based on the log information of the device, the timeout being determined to occur when not receiving the state information from the device within the first time after the first request is issued; and wherein
the first periodic collection unit and the second periodic collection unit do not issue the first request and the second request to the device whose occurrence ratio equal or exceed a predetermined first threshold.

8. The apparatus according to claim 6, further comprising:
a notifying unit configured to notify that the device whose occurrence ratio equal or exceed a predetermined second threshold which is smaller than the first threshold is detected.

9. The apparatus according to claim 7, further comprising:
a notifying unit configured to notify that the device whose occurrence ratio equal or exceed a predetermined second threshold which is smaller than the first threshold is detected.

10. An information collection methods for collecting, from a plurality of devices each having a plurality of states including a power-supply state indicating ON or OFF of a power-supply, state information indicating a state of each device, the method including:
storing, in a first memory, the power-supply state of each device;
receiving state information transmitted from each device whose state is changed;
rewriting, when a power-supply state information indicating the power-supply state is received, the power-supply state stored in the first memory in accordance with the obtained power-supply state information;
collecting periodically the state information from each device whose power-supply state stored in the first memory is ON by issuing, at regular intervals, a first request for the state information to the device; and
transmitting the state information collected periodically to an external apparatus.

11. The method according to claim 10, wherein collecting periodically includes rewriting, when not receiving the state information from the device whose power-supply state is ON within a predetermined first time after the first request is issued, the power-supply state of the device stored in the first memory to OFF.

12. The method according to claim 11, further including collecting periodically the power-supply state information from each device whose power-supply state stored in the first memory is OFF by issuing, at regular intervals, a second request for the power-supply state information to the device.

13. The method according to claim 12, wherein the collecting periodically by issuing the second request includes rewriting, when receiving the power-supply state information from the device whose power-supply state is OFF within a predetermined second time after the second request is issued, the power-supply state of the device stored in the first memory in accordance with the received power-supply state information.

14. The method according to claim 10, wherein the rewriting rewrites the power-supply state stored in the first memory to ON when the state information indicating a state other than the power-supply state is received.

15. The method according to claim 11, further including:
storing, in a second memory, every time the first request being issued to the device whose power state is ON, log information indicating whether the state information from the device is received within the first time; and
calculating an occurrence ratio of a timeout for the device based on the log information of the device, the timeout being determined to occur when not receiving the state information from the device within the first time after the first request is issued; and wherein
the first request is not issued to the device whose occurrence ratio equal or exceed a predetermined first threshold.

16. The method according to claim 12, further including:
storing, in a second memory, every time the first request being issued to the device whose power state is ON, log information indicating whether the state information from the device is received within the first time; and
calculating an occurrence ratio of a timeout for the device based on the log information of the device, the timeout being determined to occur when not receiving the state information from the device within the first time after the first request is issued; and wherein
the first request and the second request are not issued to the device whose occurrence ratio equal or exceed a predetermined first threshold.
